(19) United States
(12) Patent Application Publication
(10) Pub. No.: US 2024/0120501 A1
(43) Pub. Date: Apr. 11, 2024

(54) ELECTRODE SLURRY FOR FUEL CELL FOR FORMING A MULTILAYER STRUCTURE WITHOUT AN INTERFACE, A MULTILAYER ELECTRODE STRUCTURE USING SAME, AND A MANUFACTURING METHOD THEREOF

(71) Applicants: HYUNDAI MOTOR COMPANY, Seoul (KR); KIA CORPORATION, Seoul (KR)

(72) Inventors: Ji Hoon Yang, Hwaseong-si (KR); Geon Hee Cho, Uijeongbu-si (KR); Kook Il Han, Seongnam-si (KR); Yoon Hwan Cho, Seoul (KR)

(73) Assignees: HYUNDAI MOTOR COMPANY, Seoul (KR); KIA CORPORATION, Seoul (KR)

(21) Appl. No.: 18/202,444

(22) Filed: May 26, 2023

(30) Foreign Application Priority Data
Oct. 7, 2022 (KR) 10-2022-0128943

(51) Int. Cl. H01M 4/92; H01M 4/90

(52) U.S. Cl. CPC H01M 4/926; H01M 4/9083; H01M 2008/1095

(57) ABSTRACT

Disclosed are an electrode slurry for a fuel cell capable of forming a multilayer structure without an interface using a first support and a second support having different mesopore fractions and densities, a multilayer electrode structure using the same, and a manufacturing method thereof. The electrode slurry for a fuel cell includes a first catalyst including a first support on which a first metal is supported, a second catalyst including a second support on which a second metal is supported, an ionomer, and a solvent, the first support and the second support having different mesopore fractions and densities.

### CROSS-REFERENCE TO RELATED APPLICATION

This application claims, under 35 U.S.C. § 119(a), the benefit of and priority to Korean Patent Application No. 10-2022-0128943, filed on Oct. 7, 2022, the entire contents of which are incorporated herein by reference.

### BACKGROUND

### (a) Technical Field

The present disclosure relates to an electrode slurry for a fuel cell for forming a multilayer structure without an interface, a multilayer electrode structure using the same, and a manufacturing method thereof, in which the multilayer electrode structure is manufactured using the electrode slurry.

### (b) Background Art

Conventionally, in order to increase performance and durability of a polymer membrane fuel cell, various techniques for improving gas diffusion and water discharge properties have been continuously developed.

In particular, research has been ongoing to develop technology for a multilayer electrode structure in which electrode layers have different pore structures. A conventional method of manufacturing a multilayer electrode structure is disadvantageous in that the manufacturing process becomes very complicated because processes such as slot die, spraying, spin coating, and deposition are added to separately manufacture individual layers, and also in that quality and durability are deteriorated due to peeling or cracking of the electrode layers because interfaces are present between different kinds of electrode layers.

The statements in this BACKGROUND section merely provide background information related to the present disclosure and may not constitute prior art.

### SUMMARY OF THE DISCLOSURE

An object of the present disclosure is to provide an electrode slurry for a fuel cell for forming a multilayer structure using different pore structures without an interface, which is capable of improving quality and durability of electrode layers, a multilayer electrode structure using the same, and a manufacturing method thereof. The objects of the present disclosure are not limited to the foregoing. The objects of the present disclosure will be able to be clearly understood through the following description and to be realized by the means described in the claims and combinations thereof.

In one embodiment of the present disclosure, an electrode slurry for a fuel cell includes: a first catalyst including a first support on which a first metal is supported; a second catalyst including a second support on which a second metal is supported; an ionomer; and a solvent. In particular, the first support and the second support have different mesopore fractions and densities.

The mesopore fraction of the second support may be greater than the mesopore fraction of the first support.

The first support may have a mesopore fraction of 60% or less based on the total pore volume, and the second support may have a mesopore fraction of 80% or more based on the total pore volume.

The first support may have a particle size in a range from 0.05 to 0.2 μm, and the second support may have a particle size of 0.2 to 3 μm.

The density ratio of the second support to the first support may be in a range of 1:0.6 to 1:0.8.

The first support may include carbon black, acetylene black, Ketjen black, activated carbon, carbon nanotubes, carbon nanofibers, carbon nanowires, or combinations thereof, and the second support may include carbon black, acetylene black, Ketjen black, activated carbon, carbon nanotubes, carbon nanofibers, carbon nanowires, or combinations thereof.

The first metal may include platinum, iridium, palladium, ruthenium, alloy, or combinations thereof, and the second metal may include platinum, iridium, palladium, ruthenium, alloy, or combinations thereof.

The first catalyst may include 30 wt. % to 50 wt. % of the first metal, and the second catalyst may include 30 wt. % to 50 wt. % of the second metal.

In another embodiment of the present disclosure, a multilayer electrode structure includes: a first electrode layer including a first catalyst in which a first metal is supported on a first support; and a second electrode layer including a second catalyst in which a second metal is supported on a second support having a mesopore fraction and density different from those of the first support.

The first support may have a mesopore fraction of 60% or less based on the total pore volume, and the second support may have a mesopore fraction of 80% or more based on the total pore volume.

The first support may have a particle size in a range of 0.05 μm to 0.2 μm, and the second support may have a particle size in a range of 0.2 μm to 3 μm.

The density ratio of the second support to the first support may be in a range of 1:0.6 to 1:0.8.

The density of the first electrode layer may be different from the density of the second electrode layer.

The density of the first electrode layer may be greater than the density of the second electrode layer.

The multilayer electrode structure may not have an interface between the first electrode layer and the second electrode layer.

In one embodiment of the present disclosure, a method of manufacturing a multilayer electrode structure includes: preparing an electrode slurry by mixing a first catalyst in which a first metal is supported on a first support; a second catalyst in which a second metal is supported on a second support having a mesopore fraction and density different from those of the first support, an ionomer, and a solvent; and manufacturing a multilayer electrode structure by applying the electrode slurry onto a substrate.

In preparing the electrode slurry, mixing may be performed at a density ratio of the second support to the first support of 1:0.6-0.8. In other words, the density ratio of the second support to the first support for the mixing is in range of 1:0.6 to 1:0.8.

The first support may have a mesopore fraction of 60% or less based on the total pore volume, the second support may have a mesopore fraction of 80% or more based on the total pore volume, the first support may have a particle size in a range of 0.05 μm to 0.2 μm, and the second support may have a particle size in a range of 0.2 μm to 3 μm.

The electrode slurry may have a viscosity in a range of 40 centipoise (“cP”) to 70 cP as measured at a shear rate of 100/s.

The mixing may be performed using at least one process selected from among stirring, high-pressure dispersion, and ultrasonic dispersion.

### BRIEF DESCRIPTION OF THE DRAWINGS

The above and other features of the present disclosure are now be described in detail with reference to certain exemplary embodiments thereof illustrated in the accompanying drawings, which are given hereinbelow by way of illustration only, and thus are not limitative of the present disclosure, and wherein:

FIG. 1 schematically shows a multilayer electrode structure to which an electrode slurry according to one embodiment of the present disclosure is applied;

FIG. 2A is a cross-sectional view showing a conventional multilayer electrode structure for a fuel cell;

FIGS. 2B and 2C are SEM images showing the surface of a conventional electrode for a fuel cell;

FIG. 2D is an SEM image showing defects on the surface of the conventional electrode for a fuel cell;

FIGS. 3A and 3B show the cross-section of a multilayer electrode structure for a fuel cell manufactured in Example according to one embodiment of the present disclosure;

FIGS. 3C and 3D show the surface of the multilayer electrode structure for a fuel cell manufactured in Example according to one embodiment of the present disclosure;

FIG. 4 is a graph showing the results of measurement of constant current performance of fuel cells using electrode slurries prepared in Comparative Examples and Example according to the present disclosure; and

FIG. 5 shows the carbon supports used in Comparative Examples and Example according to the present disclosure.

### DETAILED DESCRIPTION

The above and other objects, features and advantages of the present disclosure should be more clearly understood from the following embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those having ordinary skill in the art.

Throughout the drawings, the same reference numerals refer to the same or like elements. For the sake of clarity of the present disclosure, the dimensions of structures are depicted as being larger than the actual sizes thereof. It should be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It should be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it should be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

When a component, device, element, or the like of the present disclosure is described as having a purpose or performing an operation, function, or the like, the component, device, or element should be considered herein as being “configured to” meet that purpose or to perform that operation or function.

An aspect of the present disclosure pertains to an electrode slurry for a fuel cell for forming a multilayer structure without an interface. The electrode slurry includes: a first catalyst including a first support on which a first metal is supported, and a second catalyst including a second support on which a second metal is supported, an ionomer, and a solvent. In particular, the first support and the second support have different mesopore fractions and densities.

The first catalyst includes a first support on which a first metal is supported. The first catalyst may include 30 to 50 wt. % of the first metal. If the amount of the first metal is less than 30 wt. %, the proportion of the metal is too low and performance may be deteriorated due to decreased catalytic activity, whereas if the amount of the first metal exceeds 50 wt. %, platinum may be dissolved due to excessively dense catalyst particles, and thus durability may be deteriorated, and air supply may become weak upon flooding due to a decreased electrode thickness.

The first metal may include platinum, iridium, palladium, ruthenium, alloy, or combinations thereof.

The first support may have a mesopore fraction of 60% or less based on the total pore volume. If the mesopore fraction of the first support exceeds 60%, a fine porous structure cannot be formed. The mesopore fraction is measured in the range of 2 to 50 nm according to IUPAC through BJH analysis.

The first support may have a particle size in a range of 0.05 μm to 0.2 μm.

The first support may include carbon black, acetylene black, Ketjen black, activated carbon, carbon nanotubes, carbon nanofibers, carbon nanowires, or combinations thereof.

The second catalyst includes a second support on which a second metal is supported. The second catalyst may include 30 to 50 wt. % of the second metal. If the amount of the second metal is less than 30 wt. %, the proportion of the metal is too low and performance may be deteriorated due to decreased catalytic activity, whereas if the amount of the second metal exceeds 50 wt. %, platinum may be dissolved due to excessively dense catalyst particles, and thus durability may be deteriorated, and air supply may become weak upon flooding due to a decreased electrode thickness.

The second metal may include platinum, iridium, palladium, ruthenium, alloy, or combinations thereof.

Therefore, according to the present disclosure, a hierarchical multilayer electrode structure may be designed as desired using two supports and metals of different types and functions.

The second support may have a particle size in a range of 0.2 μm to 3 μm. The second support may have a greater mesopore fraction than that of the first support. Specifically, the second support may have a mesopore fraction of 80% or more based on the total pore volume. If the mesopore fraction of the second support is less than 80%, it is impossible to form a porous structure due to decreased mesoporosity. Here, the mesopore fraction is measured in the range of 2-50 nm according to IUPAC through BJH analysis.

Moreover, the first support and the second support have different densities. Specifically, the density ratio of the second support to the first support may be in a range of 1:0.6 to 1:0.8. Here, the carbon support density may be controlled through a typical carbon processing method such as particle pulverization, activation, etc., and the method is not particularly limited.

Specifically, the tap density ratio (first support/second support) of the first support and the second support may fall in the range of 0.6 to 0.8. If the density ratio is less than 0.6, there is a great difference in density between the two carbon supports, which causes phase separation of the electrode slurry and a large number of cracks. On the other hand, if the density ratio is 0.8-1.0, the hierarchical effect is insignificant due to similar densities of the first support and the second support. In addition, if the density ratio exceeds 1.0, the layers of the first support and the second support may be reversed, making it impossible to form a sequential hierarchical structure.

The second support may include carbon black, acetylene black, Ketjen black, activated carbon, carbon nanotubes, carbon nanofibers, carbon nanowires, or combinations thereof.

Since the first support and the second support have different mesopore fractions and densities, the first catalyst and the second catalyst may have different mesopore fractions and densities.

The ionomer may include polysulfone, polyether ketone, polyether, polyester, polybenzimidazole, polyimide, Nafion, or combinations thereof.

The solvent may include ethanol, isopropyl alcohol (IPA), propanol, ethoxyethanol, butanol, ethylene glycol, distilled water, amyl alcohol, or combinations thereof.

The electrode slurry in which the first catalyst, the second catalyst, the ionomer, and the solvent are mixed may have a viscosity in a range of 40 cP to 70 cP as measured at a shear rate of 100/s.

If the viscosity of the electrode slurry exceeds 70 cP, it is difficult to move different types of catalysts having different densities in the slurry due to high viscosity and elasticity, making it difficult to form a hierarchical layer structure. On the other hand, if the viscosity of the electrode slurry is less than 40 cP, flowability of the slurry may excessively increase, making it difficult to form a desired electrode pattern, and there is a risk of catalyst ignition upon drying due to the large amount of solvent used.

Also, the viscosity of the electrode slurry according to the present disclosure may be easily controlled by changing a typical slurry composition such as slurry solid content and mixed solvent.

Another aspect of the present disclosure pertains to a multilayer electrode structure manufactured using the electrode slurry described above. The multilayer electrode structure according to the present disclosure includes a first electrode layer including a first catalyst in which a first metal is supported on a first support, and a second electrode layer including a second catalyst in which a second metal is supported on a second support having a mesopore fraction and density different from those of the first support.

The first support, the second support, the first catalyst, the second catalyst, the ionomer, the solvent, and the electrode slurry used for the multilayer electrode structure are as described above, and thus a detailed description thereof is omitted below.

The first electrode layer and the second electrode layer may have different densities. Specifically, the density of the first electrode layer may be greater than that of the second electrode layer.

This is due to different mesopore fractions and particle sizes of the first support and the second support.

The first support may have a particle size in a range of 0.05 μm to 0.2 μm, and the second support may have a particle size in a range of 0.2 μm to 3 μm.

The first support may have a mesopore fraction of 60% or less based on the total pore volume. If the mesopore fraction of the first support exceeds 60%, a fine porous structure cannot be formed. The second support may have a greater mesopore fraction than that of the first support. Specifically, the second support may have a mesopore fraction of 80% or more based on the total pore volume. If the second support has a mesopore fraction of less than 80%, it is impossible to form a porous structure due to decreased mesoporosity. Here, the mesopore fraction is measured in the range of 2-50 nm according to IUPAC through BJH analysis.

The density ratio of the second support to the first support may be in a range of 1:0.6 to 1:0.8.

Specifically, the tap density ratio (first support/second support) of the first support and the second support may fall in the range of 0.6 to 0.8. If the density ratio is less than 0.6, there is a great difference in density between the two carbon supports, which causes phase separation of the electrode slurry and a large number of cracks. On the other hand, if the density ratio is 0.8-1.0, the hierarchical effect is insignificant due to similar densities of the first support and the second support. Also, if the density ratio exceeds 1.0, the layers of the first support and the second support may be reversed, making it impossible to form a sequential hierarchical structure.

Accordingly, the multilayer electrode structure according to the present disclosure is configured such that there is no interface between the first electrode layer and the second electrode layer.

The multilayer electrode structure according to the present disclosure is specified below with reference to the accompanying drawings.

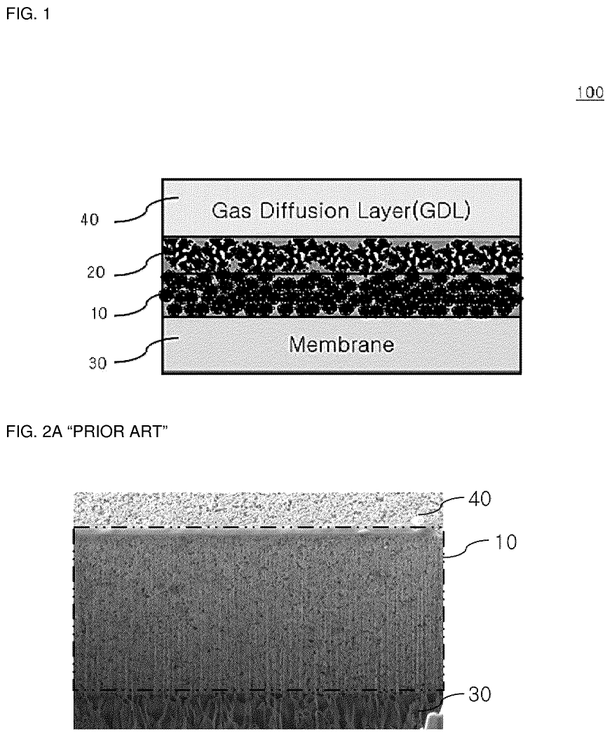

FIG. 1 schematically shows the multilayer electrode structure to which the electrode slurry according to one embodiment of the present disclosure is applied. With reference to FIG. 1, in an electrode structure 100 to which the electrode slurry is applied, a first electrode layer 10 facing the interface of a gas diffusion layer 40 has a porous structure, thus attaining fast mass transfer capacity, and a second electrode layer 20 facing the interface of an electrolyte membrane 30 has more dense pores, thereby forming a double electrode layer without an interface capable of maximizing water discharge properties through a capillary phenomenon.

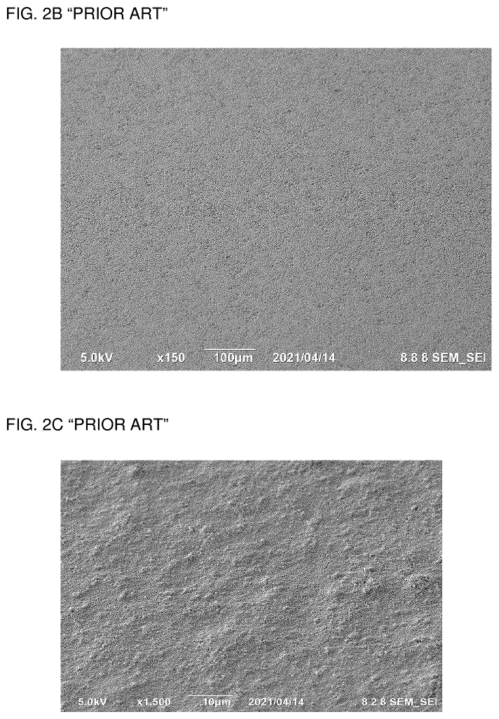

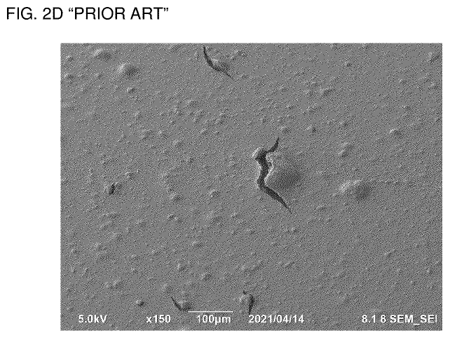

FIG. 2A is a cross-sectional view showing a conventional multilayer electrode structure for a fuel cell. With reference to FIG. 2A, a first electrode layer 10 in which small pores are densely present in the electrode due to the use of a single type of carbon support may be provided between a gas diffusion layer 40 and an electrolyte membrane 30.

FIG. 2B is an SEM image showing the surface of a conventional electrode for a fuel cell at 150× magnification, and FIG. 2C shows a 10X magnified image of FIG. 2B.

Also, as shown in FIG. 2D, in the conventional electrode layer structure, surface cracking may occur because an interface exists between the layers. Here, FIG. 2D is an SEM image showing defects on the surface of the conventional electrode for a fuel cell.

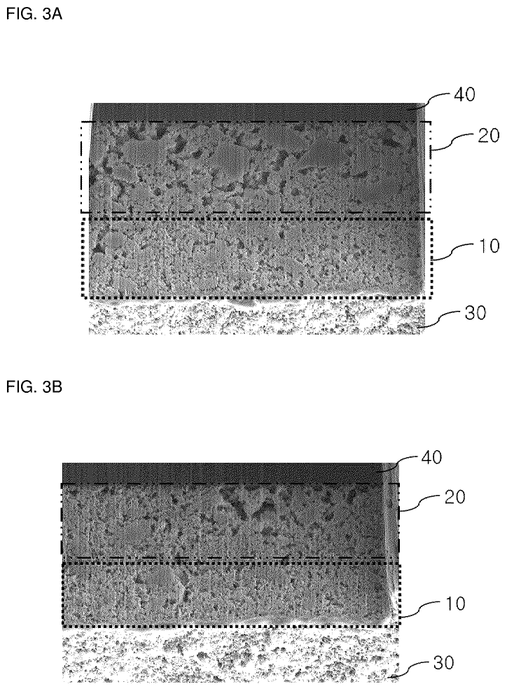

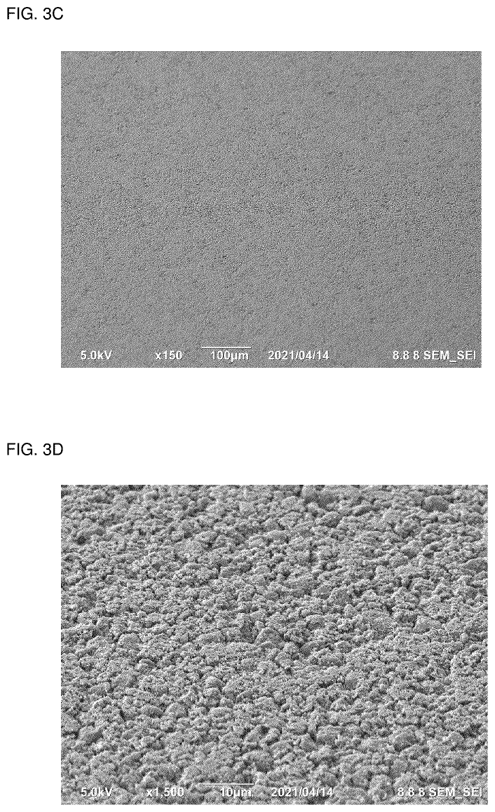

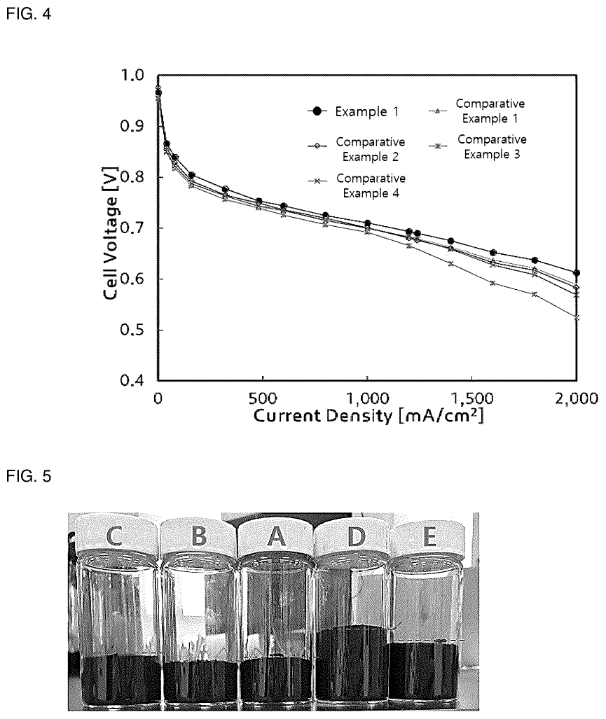

In contrast, FIGS. 3A and 3B show the cross-section of a multilayer electrode structure for a fuel cell manufactured in Example according to one embodiment of the present disclosure. FIG. 3C is an SEM image showing the surface of the electrode for a fuel cell having a multilayer structure manufactured in Example according to the present disclosure at 150× magnification, and shows a 10X magnified image of FIG. 3B.

As shown in FIGS. 3A and 3B, the electrode in which a first electrode layer 10 having a porous structure and a second electrode layer 20 having pores denser than the first electrode layer 10 are provided without an interface therebetween is manufactured, whereby material (gas/water) transfer capacity in the electrode may be increased due to a capillary phenomenon, and thus, durability and cell performance may also be improved.

Still another aspect of the present disclosure pertains to a method of manufacturing a multilayer electrode structure for a fuel cell for forming a multilayer structure without an interface.

The method of manufacturing the multilayer electrode structure according to the present disclosure includes: preparing an electrode slurry by mixing a first catalyst in which a first metal is supported on a first support, a second catalyst in which a second metal is supported on a second support having a mesopore fraction and density different from those of the first support, an ionomer, and a solvent; and manufacturing a multilayer electrode structure by applying the electrode slurry onto a substrate.

The first support, the second support, the first catalyst, the second catalyst, the ionomer, the solvent, and the electrode slurry used in the method of manufacturing the multilayer electrode structure are as described above, and thus a detailed description thereof is omitted below.

First, in preparing the electrode slurry, the first catalyst, the second catalyst, and the ionomer may be added to the solvent and mixed together.

The mixing process may be performed using at least one selected from among stirring, high-pressure dispersion, and ultrasonic dispersion, and the electrode slurry may be prepared through a typical mixing process.

In preparing the electrode slurry, the density ratio of the second support to the first support may be in a range of 1:0.6-0.8.

Specifically, the tap density ratio (first support/second support) of the first support and the second support may fall in the range of 0.6 to 0.8. If the density ratio is less than 0.6, there is a great difference in density between the two carbon supports, which causes phase separation of the electrode slurry and a large number of cracks. On the other hand, if the density ratio is 0.8-1.0, the hierarchical effect is insignificant due to similar densities of the first support and the second support. Also, if the density ratio exceeds 1.0, the layers of the first support and the second support may be reversed, making it impossible to form a sequential hierarchical structure.

Here, the first support may have a particle size in a range of 0.05 μm to 0.2 μm, and the second support may have a particle size in a range of 0.2 μm to 3 μm. Also, the first support may have a mesopore fraction of 60% or less based on the total pore volume, and the second support may have a mesopore fraction of 80% or more based on the total pore volume. If the mesopore fraction of the first support exceeds 60%, it is impossible to form a fine porous structure. If the second support has a mesopore fraction of less than 80%, it is impossible to form a porous structure due to decreased mesoporosity. Here, the mesopore fraction is measured in the range of 2-50 nm according to IUPAC through BJH analysis.

The electrode slurry prepared in the step of preparing the electrode slurry may have a viscosity of in a range 40 cP to 70 cP as measured at a shear rate of 100/s.

If the viscosity of the electrode slurry exceeds 70 cP, it is difficult to move different types of catalysts having different densities in the slurry due to high viscosity and elasticity, making it difficult to form a hierarchical layer structure. On the other hand, if the viscosity of the electrode slurry is less than 40 cP, flowability of the slurry may be excessively increased, making it difficult to form a desired electrode pattern, and there is a risk of catalyst ignition upon drying due to the large amount of solvent used.

Then, in the step of manufacturing the multilayer electrode structure, the electrode slurry is applied onto the substrate. Here, the substrate may be a typical substrate material used in electrode manufacturing methods.

The multilayer electrode structure according to the present disclosure may be manufactured using a typical technique, but the present disclosure is not limited thereto. Specifically, it may be manufactured by coating a release paper with the electrode slurry prepared by the method according to the present disclosure using a process such as spraying, bar coating, slot-die coating, or the like. Here, when the multilayer electrode structure is manufactured using a release paper during the manufacturing process, an electrode membrane assembly may be manufactured by transferring the manufactured multilayer electrode structure to an electrolyte membrane. As such, a hot-pressing process may be used for transferring the multilayer electrode structure.

When the electrode membrane assembly is manufactured by directly coating the electrolyte membrane with the multilayer electrode structure, there is no need for an electrode transfer process.

Accordingly, in the present disclosure, a hierarchical multilayer electrode structure having different pores may be designed even without a separate coating or an additional process through simple optimization of the slurry composition. A better understanding of the present disclosure may be obtained through the following examples. These examples are merely set forth to illustrate the present disclosure, and are not to be construed as limiting the scope of the present disclosure.

As shown in Table 1 below, by changing the mesopore fraction of the second carbon support, the density ratio of the first carbon support and the second carbon support, and the viscosity of the electrode slurry, electrode performance was determined through voltage measurement at 1.8 A/cm².

### EXAMPLES

An electrode slurry was prepared by mixing a first catalyst, a second catalyst, and an ionomer with a solvent through a typical method. Here, mixing was performed using any one process selected from among stirring, high-pressure dispersion, and ultrasonic dispersion. Then, electrodes according to Example and Comparative Examples were manufactured through a process such as bar coating, slot-die coating, etc. using the prepared slurry.

Here, the first catalyst is a metal catalyst supported on a first carbon support, and the second catalyst is a metal catalyst supported on a second carbon support. The metal catalyst may include a noble metal such as platinum, palladium, iridium, rhodium, gold, silver, etc., a transition metal such as cobalt, nickel, etc., or a binary or ternary or more alloy catalyst thereof. Each of the first carbon support and the second carbon support may include carbon black, acetylene black, Ketjen black, activated carbon, carbon nanotubes, carbon nanofibers, carbon nanowires, or combinations thereof. Here, the amount of platinum at the cathode was 0.2 mg/cm².

TABLE 1

| | Mesopore | Density ratio of | Viscosity | |
|---|---|---|---|---|
| | fraction | carbon supports | of electrode | High-output |
| | of second | (first carbon | slurry | performance |
| Class- | carbon | support/second | (@ shear | (@ |
| ification | support | carbon support) | rate 100) | 1.8 A/cm²) |
| Example 1 | 84% | 0.75 | 45 (cP) | 0.638 |
| Comparative | 72% | 0.72 | 43 (cP) | 0.621 |
| Example 1 | | | | |
| Comparative | 84% | 0.95 | 48 (cP) | 0.617 |
| Example 2 | | | | |
| Comparative | 84% | 1.20 | 48 (cP) | 0.570 |
| Example 3 | | | | |
| Comparative | 84% | 0.75 | 82 (cP) | 0.609 |
| Example 4 | | | | |

FIG. 5 shows the carbon supports used in Comparative Examples and Example according to the present disclosure. Here, “A” is the second carbon support used in Example 1, “B” is the second carbon support used in Comparative Example 1, “C” is the second carbon support used in Comparative Example 2, “D” is the second carbon support used in Comparative Example 3, and “E” is the first carbon support used in Example 1 and Comparative Examples 1-4.

With reference to FIG. 5, the use of different densities and mesopore fractions can be confirmed. Specifically, in the present disclosure, the mesopore fraction of the second carbon support was greater than that of the first carbon support.

As shown in Table 1, Comparative Example 1, in which the mesopore fraction of the second carbon support was less than 80%, exhibited deteriorated high-output performance due to insufficient mesopores.

In Comparative Example 2, in which the density ratio of the carbon supports (first carbon support/second carbon support) was in the range of 0.8-1.0, movement of carbon having different pores due to similar densities was restricted, and as such, high-output performance was deteriorated due to random arrangement rather than hierarchical layer arrangement.

Also, in Comparative Example 3, in which the density ratio of the carbon supports (first carbon support/second carbon support) was greater than 1.0, the hierarchical arrangement was reversed, such that the extent of reduction of high-output performance was great due to decreased mass transfer capacity and water discharge properties.

Also, in Comparative Example 4, in which the viscosity of the catalyst slurry was greater than 60 cP, high-output performance was deteriorated because movement of carbon having different pores was restricted.

In contrast, Example 1, in which the density ratio of the second support to the first support was in a range of 1:0.6-0.8, the second support had a mesopore fraction of 80% or more based on the total pore volume, and the viscosity of the electrode slurry was measured to be in a range of 40 to 70 cP at a shear rate of 100/s, exhibited superior performance compared to Comparative Examples that did not satisfy the above ranges.

Therefore, the present disclosure is capable of forming a hierarchical electrode structure without an interface through simple mixing of different types of catalysts rather than conventional double coating for layers, by specifying physical properties such as density, size, and pores of carbon, and viscosity of the slurry.

In the multilayer electrode structure of the present disclosure, different pore structures are hierarchically configured, and the layers are continuously formed without any interface therebetween, thus exhibiting superior MEA quality and durability compared to the existing structures with interfaces.

Therefore, the present disclosure improves or maximizes gas diffusion properties and water discharge because there is no interface between the first electrode layer having a porous structure facing the interface of the gas diffusion layer to which fuel gas is directly supplied and the second electrode layer having a dense pore structure facing the interface of the electrolyte membrane.

As is apparent from the above description, according to the present disclosure, a first electrode layer facing the interface of a gas diffusion layer to which fuel gas is directly supplied has a porous structure to thus obtain fast mass transfer capacity, and a second electrode layer facing the interface of an electrolyte membrane has more dense pores, making it possible to manufacture a double electrode layer without an interface capable of maximizing water discharge properties through a capillary phenomenon.

In addition, a multilayer electrode structure according to the present disclosure can maximize gas diffusion and water discharge properties by forming a double porous layer in which an interlayer interface does not exist.

In addition, the present disclosure can design a hierarchical multilayer electrode structure having different pores without a separate coating or an additional process through simple optimization of the slurry composition.

The effects of the present disclosure are not limited to the above-mentioned effects. It should be understood that the effects of the present disclosure include all effects that can be inferred from the description of the present disclosure.

Although specific embodiments of the present disclosure have been described with reference to the accompanying drawings, those having ordinary skill in the art should appreciate that the present disclosure may be embodied in other specific forms without changing the technical spirit or essential features thereof. Thus, the embodiments described above should be understood to be non-limiting and illustrative in every way.

What is claimed is:

1. An electrode slurry for a fuel cell, comprising:
a first catalyst comprising a first support on which a first metal is supported;
a second catalyst comprising a second support on which a second metal is supported;
an ionomer; and
a solvent;
wherein the first support and the second support have different mesopore fractions and densities.

2. The electrode slurry of claim 1, wherein a mesopore fraction of the second support is greater than a mesopore fraction of the first support.

3. The electrode slurry of claim 1, wherein the first support has a mesopore fraction of 60% or less based on a total pore volume, and the second support has a mesopore fraction of 80% or more based on the total pore volume.

4. The electrode slurry of claim 1, wherein the first support has a particle size in a range of 0.05 μm to 0.2 μm, and the second support has a particle size in a range of 0.2 μm to 3 μm.

5. The electrode slurry of claim 1, wherein a density ratio of the second support to the first support is in a range of 1:0.6 to 1:0.8.

6. The electrode slurry of claim 1, wherein:
the first support comprises carbon black, acetylene black, Ketjen black, activated carbon, carbon nanotubes, carbon nanofibers, carbon nanowires, or combinations thereof, and
the second support comprises carbon black, acetylene black, Ketjen black, activated carbon, carbon nanotubes, carbon nanofibers, carbon nanowires, or combinations thereof.

7. The electrode slurry of claim 1, wherein:
the first metal comprises platinum, iridium, palladium, ruthenium, alloy, or combinations thereof, and
the second metal comprises platinum, iridium, palladium, ruthenium, alloy, or combinations thereof.

8. The electrode slurry of claim 1, wherein:
the first catalyst comprises 30 wt % to 50 wt % of the first metal, and
the second catalyst comprises 30 wt % to 50 wt % of the second metal.

9. A multilayer electrode structure, comprising:
a first electrode layer comprising a first catalyst in which a first metal is supported on a first support; and
a second electrode layer comprising a second catalyst in which a second metal is supported on a second support having a mesopore fraction and density different from a mesopore fraction and density of the first support.

10. The multilayer electrode structure of claim 9, wherein the first support has a mesopore fraction of 60% or less based on a total pore volume, and the second support has a mesopore fraction of 80% or more based on the total pore volume.

11. The multilayer electrode structure of claim 9, wherein the first support has a particle size in a range of 0.05 μm to 0.2 μm, and the second support has a particle size in a range of 0.2 μm to 3 μm.

12. The multilayer electrode structure of claim 9, wherein a density ratio of the second support to the first support is in a range of 1:0.6 to 1:0.8.

13. The multilayer electrode structure of claim 9, wherein a density of the first electrode layer is different from a density of the second electrode layer.

14. The multilayer electrode structure of claim 9, wherein a density of the first electrode layer is greater than a density of the second electrode layer.

15. The multilayer electrode structure of claim 9, wherein the multilayer electrode structure does not have an interface between the first electrode layer and the second electrode layer.

16. A method of manufacturing a multilayer electrode structure, the method comprising:
preparing an electrode slurry by mixing a first catalyst in which a first metal is supported on a first support, a second catalyst in which a second metal is supported on a second support having a mesopore fraction and density different from a mesopore fraction and density of the first support, an ionomer, and a solvent; and
manufacturing a multilayer electrode structure by applying the electrode slurry onto a substrate.

17. The method of claim 16, wherein, in preparing the electrode slurry, mixing is performed at a density ratio of the second support to the first support in a range of 1:0.6 to 1:0.8.

18. The method of claim 16, wherein:
the first support has a mesopore fraction of 60% or less based on a total pore volume, and the second support has a mesopore fraction of 80% or more based on the total pore volume, and
the first support has a particle size in a range of 0.05 μm to 0.2 μm, and the second support has a particle size in a range of 0.2 μm to 3 μm.

19. The method of claim 16, wherein the electrode slurry has a viscosity in a range of 40 cP to 70 cP as measured at a shear rate of 100/s.

20. The method of claim 16, wherein the mixing is performed using at least one process selected from among stirring, high-pressure dispersion, and ultrasonic dispersion.
